(19) United States
(12) Patent Application Publication
(10) Pub. No.: US 2017/0310766 A1
(43) Pub. Date: Oct. 26, 2017

(54) SERVICE STATE DETERMINING METHOD FOR SERVICE PROCESSING DEVICE AND SCHEDULING DEVICE

(71) Applicants: Le Holdings (Beijing) Co., Ltd., Beijing (CN); Le Cloud Computing Co., Ltd., Beijing (CN)

(72) Inventor: Yangang XIA, Beijing (CN)

(21) Appl. No.: 15/342,536

(22) Filed: Nov. 3, 2016

Related U.S. Application Data
(63) Continuation of application No. PCT/CN2016/100060, filed on Sep. 26, 2016.

(30) Foreign Application Priority Data
Apr. 25, 2016 (CN) 201610264225.7

(51) Int. Cl. H04L 29/08

(52) U.S. Cl. CPC H04L 67/16; H04L 67/32

(57) ABSTRACT

The embodiments of the present application provide a service state determining method for a service processing device and a scheduling device. In the method, the scheduling device can determine the service state of the service processing device by sending the service request to the service processing device and determining to receive the response message returned by the service processing device for the service request, thus, the scheduling device can allocate the service processing device for this service request according to the service state of the service processing device subsequently, thereby avoiding the problem that the service processing device allocated for the service request by the scheduling device cannot process this service request, ensuring that the service requested by the service request can be normally realized, improving the safety and stability of the network and improving user's experience.

### CROSS-REFERENCE TO RELATED APPLICATIONS

This application is a continuation of International Application No. PCT/CN2016/100060, filed on Sep. 26, 2016, which is based upon and claims priority to Chinese Patent Application No. 201610264225.7, filed on Apr. 25, 2016. All of the aforementioned applications are incorporated herein in their respective entireties by this reference.

### TECHNICAL FIELD

The present application relates to the field of communication technology, and in particular to a service state determining method for a service processing device and a scheduling device.

### BACKGROUND

Along with the development of network communication, the demands of users on a data transmission speed and stability of internet are higher and higher. In order to meet the above demands of the users, the application of a Content Delivery Network (CDN) technology becomes wider and wider. By adopting the CDN technology, network phenomena such as a slower opening speed of a website caused by problems of cross-operator, cross-region, overlow load capacity of a server, too less widebands, or the like, can be solved, thereby realizing network accelerating.

The CDN includes a scheduling device for service scheduling, and a plurality of service processing devices, where the scheduling device is configured to receive a service request of the user, allocate a corresponding service processing device for the service request, and send the service request to the service processing device; the service processing device is configured to process the service request and realize a service corresponding to the service request.

The allocation of the corresponding service processing device for the service request by the scheduling device in the CDN is based on an operation state of the service processing device. The scheduling device detects and updates the operation state of the service processing device in the CDN, for example, through heartbeat detection or fault detection. Thus, when the scheduling device needs to allocate the service processing device for a service request, the scheduling device selects one service processing device with normal operation state from a plurality of service processing devices and allocates to the service request.

However, in real application, not all service processing devices in the CDN can process various service requests, when the service processing device allocated by the scheduling device for the service request cannot process this service request, as a result, the service requested by the service request cannot be realized, thereby the safety and stability of the CDN network are reduced and user's experience is further reduced.

### SUMMARY

The embodiments of the present application provide a service state determining method for a service processing device and a scheduling device, aiming to solve the problem in the prior art that the service processing device allocated by the scheduling device for the service request cannot process this service request.

In a first aspect, the embodiment of the present application provides a service state determining method for a service processing device, including:

sending, by a scheduling device, a service request to a service processing device;

determining, by the scheduling device, to receive a response message returned by the service processing device for the service request, and determining that a service state of the service processing device is that the service processing device can process the service request, where the response message is returned to the scheduling device after the service request is received by the service processing device in a case that the service processing device can process the service request.

In a second aspect, the embodiment of the present application further provides a non-transitory computer storage medium storing a computer executable instruction, and the computer executable instruction is set for:

sending a service request to a service processing device; and

determining to receive a response message returned by the service processing device for the service request, and determining that a service state of the service processing device is that the service processing device can process the service request, wherein the response message is returned to the scheduling device after the service request is received by the service processing device in a case that the service processing device can process the service request.

In a third aspect, the embodiment of the present application further provides a scheduling device, including at least one processor and a memory, where the memory stores a program executable by the at least one processor, and execution of the instructions by the at least one processor causes the at least one processor to:

send a service request to a service processing device; and

determine to receive a response message returned by the service processing device for the service request, and determine that a service state of the service processing device is that the service processing device can process the service request, wherein the response message is returned to the scheduling device after the service request is received by the service processing device in a case that the service processing device can process the service request.

According to the service state determining method for the service processing device and the scheduling device provided by the present application, the scheduling device can determine the service state of the service processing device by sending the service request to the service processing device and determining to receive the response message returned by the service processing device for the service request, thus, the scheduling device can allocate the service processing device for this service request according to the service state of the service processing device subsequently, thereby avoiding the problem that the service processing device allocated for the service request by the scheduling device cannot process this service request, ensuring that the service requested by the service request can be normally realized, improving the safety and stability of the network and improving user's experience.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a service state determining method for a service processing device in accordance with some embodiments;

FIG. 2 is a structural schematic diagram of a scheduling device in accordance with some embodiments;

FIG. 3 is a structural schematic diagram of another scheduling device in accordance with some embodiments; and

FIG. 4 is a schematic diagram of an electronic device for determining service state of a service processing device in accordance with some embodiments.

### DETAILED DESCRIPTION

In order to make the objective, technical solution and advantages of the embodiments of the present application more apparent, the technical solution in the embodiments of the present application will be clearly and completely described below with reference to the drawings in the embodiments of the present application. Obviously, the embodiments to be described are just partial embodiments of the present application instead of all embodiments. Based upon the embodiments here of the application, all of other embodiments derived by those ordinarily skilled in the art without any inventive effort shall come into the scope of the application.

According to the service state determining method for the service processing device and the scheduling device provided by the present application, the scheduling device can determine the service state of the service processing device by sending the service request to the service processing device and receiving the response message returned by the service processing device for the service request, thus, the scheduling device can allocate the service processing device for this service request according to the service state of the service processing device subsequently, thereby avoiding the problem that the service processing device allocated for the service request by the scheduling device cannon process this service request, ensuring that the service requested by the service request can be normally realized, improving the safety and stability of the network and improving user's experience.

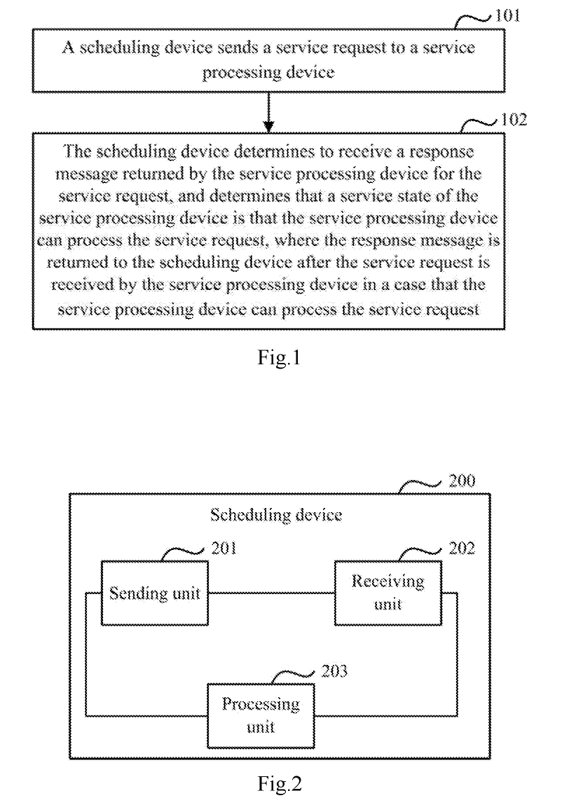

The service state determining method for the service processing device provided by the embodiment of the present application is applicable to various networks including the scheduling device, for example, a CDN network, where the scheduling device is a device for performing resource scheduling on various services. FIG. 1 shows a flow of the service state determining method for the service processing device provided by an embodiment of the present application, which specifically includes:

Step 101: a scheduling device sends a service request to a service processing device.

The service processing device can be any one service processing device in a current network, or any service processing device with a normal operation state, or a service processing device designated by the scheduling device or a user, which is not limited by the embodiment of the present application. The service processing device can be a service server, a computer and other devices capable of realizing some services, which is not limited by the embodiment of the present application.

The scheduling device can perform the step 101 by but not limited to the following two approaches:

First approach: after receiving the service request, the scheduling device stores the service request and sends the service request to the service processing device.

Second approach: the scheduling device sends a preset service request to the service processing device.

In the first approach, the moment when the scheduling device sends the service request can be after the scheduling device receives the service request, where the service request is sent by the user for realizing some type of service, at this point, the scheduling device can judge a service state of the service processing device through the service request, but the scheduling device needs to locally store the service request, for example, cache the service request to a buffer, then, after determining the service state of the service processing device, the scheduling device can continue to follow up the service state of the service processing device, and allocates the service processing device for the service request, thereby ensuring that all requested services can be realized normally.

In the second approach, the scheduling device can pre-store a template of a plurality of service requests, and the scheduling device can send any one service request to the service processing device for judging the service state of the service processing device, i.e., whether the service processing device can process the service request.

In the embodiment of the present application, the moment to perform the step 101 is not limited, in the first approach, the scheduling device can perform step 101 after receiving the service request; and in the second approach, the scheduling device can perform the step 101 in accordance with a preset period, or perform the step 101 when the operation state of the service processing device is determined to be normal, or perform the step 101 when the service processing device is started.

Optionally, in a case that the scheduling device can determine an operation state of the service processing device, before the scheduling device performs the step 101, the method further includes:

The scheduling device determines that the operation state of the service processing device is normal.

The scheduling device can determine the operation state of one service processing device through heartbeat detection or various conventional fault detection methods, which is not limited by the embodiment of the present application.

Since only the service processing device with the normal operation state can process the service request, with the method, the scheduling device can be avoided from sending the service request to the service processing device with a faulty operation state, and the resource waste of the scheduling device can be avoided.

Step 102: the scheduling device determines to receive a response message returned by the service processing device for the service request, and determines that a service state of the service processing device is that the service processing device can process the service request, where the response message is returned to the scheduling device after the service request is received by the service processing device in a case that the service processing device can process the service request.

Usually, after one service processing device receives one service request, in a case that the service processing device can process the service request, a corresponding response message is usually sent to the device sending the service request; in a case that the service processing device cannot process the service request, a notification message may be returned, or no response is made, that is, no information is returned.

Optionally, the scheduling device determines not to receive the response message returned by the service processing device, and determines that the service state of the service processing device is that the service processing device cannot process the service request. The scheduling device determines not to receive the response message returned by the service processing device in two cases: in one case, the scheduling device receives information of the service processing device but such information is not the response message; in the other case, the service processing device does not send any message to the scheduling device.

In a real application scenario, after the scheduling device sends the service request to the service processing device, there are two results: in the first result, the scheduling device receives the information sent from the service processing device; in the second result, the scheduling device does not receive any information sent from the service processing device. Obviously, under the second result, the scheduling device can determine that the service processing device cannot process the service request.

Under the first result, optionally, the step of determining to receive the response message returned by the service processing device by the scheduling device includes:

The scheduling device receives information sent from the service processing device;

The scheduling device acquires the stored response message, and matches the response message with the information; and

The scheduling device determines to receive the response message returned by the service processing device upon determining that the response message and the information are matched.

The response message corresponding to the request message is stored in the scheduling device, thus, when the information sent from the service processing device is received, it can be judged whether the information is the response message corresponding to the request message, and the service state of the service processing device can be further determined.

After the step 102, after determining the service state of the service processing device, the scheduling device stores the service state of the service processing device, thus, after receiving the service request subsequently, the scheduling device can continue to follow up the service state of the service processing device, and allocate the service processing device for the received service request.

With the method, the scheduling device can determine the service state of the service processing device when sending the service request to the service processing device and determining to receive the response message returned by the service processing device for the service request, thus, the scheduling device can allocate the service processing device for this service request according to the service state of the service processing device subsequently, thereby avoiding the problem that the service processing device allocated for the service request by the scheduling device cannot process this service request, ensuring that the service requested by the service request can be normally realized, improving the safety and stability of the network and improving user's experience.

In a real application scenario, the scheduling device can send a plurality of service requests of a plurality of service types (for example, live, on demand, etc.) to a plurality of service processing devices simultaneously, thus, the scheduling device can determine the service states of the plurality of service processing devices in processing the plurality of service types using the above method, thereby improving the working efficiency of the scheduling device in determining the service state of the service processing device.

Based on the same inventive concept, an embodiment of the present application further provides a scheduling device, where the scheduling device can realize the service state determining method for the service processing device as shown in FIG. 1. Since the problem solving principle of the above scheduling device is the same to the determining principle of the service state of the service processing device, the implementation of the scheduling device can refer to that of the method, and is not repeated. Referring to the structural schematic diagram of the scheduling device as shown in FIG. 2, the scheduling device 200 includes a sending unit 201, a receiving unit 202 and a processing unit 203, where:

The sending unit 201 is configured to send a service request to a service processing device;

The receiving unit 202 is configured to receive a response message returned by the service processing device for the service request, where the response message is returned to the scheduling device after the service request is received by the service processing device in a case that the service processing device can process the service request;

The processing unit 203 is configured to determine the receiving unit 202 to receive the response message returned by the service processing device for the service request, and determine that a service state of the service processing device is that the service processing device can process the service request.

Optionally, the processing unit 203 is further configured to:

Determine the receiving unit 202 not to receive the response message returned by the service processing device, and determine that the service state of the service processing device is that the service processing device cannot process the service request.

Optionally, the receiving unit 202 is further configured to receive the service request before the sending unit 201 sends the service request to the service processing device; and the processing unit 203 is further configured to store the service request; or

The processing unit 203 is further configured to acquire a preset service request before the sending unit 201 sends the service request to the service processing device.

Optionally, the processing unit 203 is further configured to:

Determine that an operation state of the service processing device is normal before the sending unit 201 sends the service request to the service processing device.

Optionally, the receiving unit 202 is further configured to receive information sent from the service processing device;

The processing unit 203 determining the receiving unit 202 to receive the response message returned by the service processing device includes:

Acquire the stored response message, and match the response message with the information;

Determine to receive the response message returned by the service processing device upon determining that the response message and the information are matched.

For the convenience of description, above respective portions are divided into respective modules (or units) according to functions to be respectively described. Of course, the functions of respective modules (or units) can be implemented in one or more software or hardware in implementing the present application. In particular implementation, the scheduling device can be disposed in a scheduling server.

Based on the above embodiments, the embodiment of the present application further provides a non-transitory computer storage medium storing a computer executable instruction, where the computer executable instruction can perform the service state determining method for the service processing device in the method embodiment.

Based on the above embodiments, the embodiment of the present application further provides a computer program product, the computer program product includes a computer program stored on the non-transitory computer storage medium, the computer program includes program instructions, and the program instructions, when being executed by a computer, cause the computer to perform the above service state determining method for the service processing device of the present application.

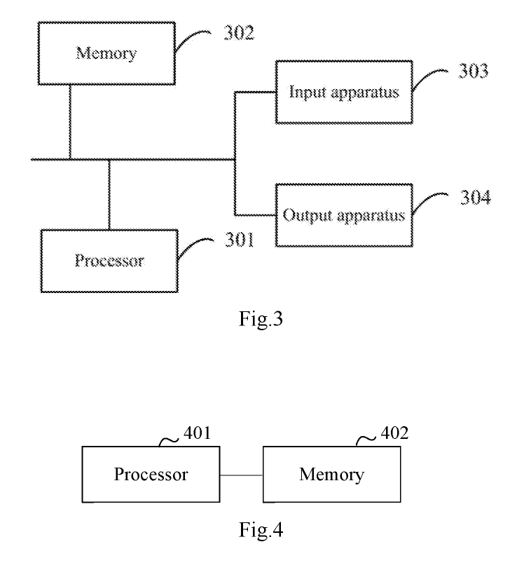

Based on the above embodiments, the embodiment of the present application further provides a scheduling device, referring to the structural schematic diagram as shown in FIG. 3, the scheduling device includes: at least one processor 301 (FIG. 3 takes one processor 301 as an example), a memory 302, an input apparatus 303 and an output apparatus 304, where the processor 301, the memory 302, the input apparatus 303 and the output apparatus 304 are in communication connection. Optionally, the above modules can be connected via a bus or other manners, and FIG. 3 takes the bus connection as an example.

The memory 302 as a non-transitory computer storage medium can be configured to store non-transitory software programs, and non-transitory computer executable programs and modules, for example, the program instructions/modules corresponding to the service state determining method for the service processing device in the embodiment of the present application (for example, the sending unit 201, the receiving unit 202 and the processing unit 203 as shown in FIG. 2). The processor 301 performs various function applications and data processing of the scheduling device by executing the non-transitory software programs, instructions and modules stored in the memory 302, that is, the service state determining method for the service processing device in the above method embodiment is realized.

The memory 302 can include a program storing region and a data storing region, where the program storing region can store an operation system and the application program required by at least one function; the data storing region can store various data, such as a preset service request, a response message for matching etc. In addition, the memory 302 can include a high speed random access memory, and can also include a non-transitory memory, for example at least one disk memory device, a flash device or other non-transitory solid memory devices. In some embodiments, the memory 302 can include memories remotely disposed relative to the processor 301, and these remote memories can be connected to processing apparatuses of list item operation via a network. The instances of the network include but not limited to internet, enterprise intranet, local area network, mobile communication network and combinations thereof.

The input apparatus 303 can receive various messages sent from other devices connected to the scheduling device, for example, the service request. The output apparatus 304 can send various messages to other devices connected to the scheduling device, for example, send the service request to the service processing device.

The one or more modules are stored in the memory 302, and execute the service state determining method for the service processing device in any above method embodiment when executed by one or more processors 301.

The above product can execute the method provided by the embodiment of the present application, and has corresponding function modules for executing the method and advantageous effects. The technical details not described in detail in the present embodiment can refer to the method provided by the embodiments of the present application.

Based upon the same inventive idea, an embodiment of the disclosure further provides an electronic device for determining service state of a service processing device, as illustrated in FIG. 4, which includes:

At least one processor 401 and a memory 402, where there is one processor as an example in FIG. 4.

The memory 402 is communicably connected with the at least one processor 401 for storing instructions executable by the at least one processor, wherein execution of the instructions by the at least one processor causes the at least one processor to:

Send a service request to a service processing device; and

Determine to receive a response message returned by the service processing device for the service request, and determine that a service state of the service processing device is that the service processing device can process the service request, wherein the response message is returned to the scheduling device after the service request is received by the service processing device in a case that the service processing device can process the service request.

In one embodiment, the execution of the instructions by the at least one processor further causes the at least one processor to:

Determine not to receive the response message returned by the service processing device, and determine that the service state of the service processing device is that the service processing device cannot process the service request.

In one embodiment, the execution of the instructions by the at least one processor further causes the at least one processor to:

Store the service request after receiving the service request, and send the service request to the service processing device; or

Send a preset service request to the service processing device.

In one embodiment, the execution of the instructions by the at least one processor further causes the at least one processor to:

Determine that an operation state of the service processing device is normal before sending a service request to a service processing device.

In one embodiment, the execution of the instructions by the at least one processor further causes the at least one processor to:

Receive information sent from the service processing device;

Acquire the stored response message, and matching the response message with the information; and

Determine to receive the response message returned by the service processing device upon determining that the response message and the information are matched.

The electronic device according to some embodiments of the disclosure can be in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents.

These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

The embodiments of the apparatus described above are merely exemplary, where the units described as separate components may or may not be physically separate, and the components illustrated as elements may or may not be physical units, that is, they can be collocated or can be distributed onto a plurality of network elements. A part or all of the modules can be selected as needed in reality for the purpose of the solution according to the embodiments of the application. This can be understood and practiced by those ordinarily skilled in the art without any inventive effort.

Through the description on the embodiments, those skilled in the art can clearly know that respective embodiments can be implemented by means of software plus necessary a universal hardware platform, or by hardware of course. Based on such understanding, the above technical solution or the part contributing to the prior art can be embodied in a software product manner essentially, the computer software product can be stored in the computer readable storage medium, for example, ROM/RAM, a disk, a compact disk, etc., and includes a plurality of instructions to enable a computer device (which can be a personal computer, a server, or a network device, etc.) to execute the method according to respective embodiments or some parts of the embodiments.

Lastly it shall be noted that the respective embodiments above are merely intended to illustrate but not to limit the technical solution of the application; and although the application has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the application as claimed.

What is claimed is:

1. A service state determining method for a service processing device, comprising:
sending, by a scheduling device, a service request to a service processing device; and
determining, by the scheduling device, to receive a response message returned by the service processing device for the service request, and determining that a service state of the service processing device is that the service processing device can process the service request, wherein the response message is returned to the scheduling device after the service request is received by the service processing device in a case that the service processing device can process the service request.

2. The method according to claim 1, wherein the method further comprises:
determining, by the scheduling device, not to receive the response message returned by the service processing device, and determining that the service state of the service processing device is that the service processing device cannot process the service request.

3. The method according to claim 1, wherein the sending, by a scheduling device, a service request to a service processing device comprises:
storing, by the scheduling device, the service request, after receiving the service request, and sending the service request to the service processing device; or
sending, by the scheduling device, a preset service request to the service processing device.

4. The method according to claim 1, before the sending, by a scheduling device, a service request to a service processing device, further comprising:
determining, by the scheduling device, that an operation state of the service processing device is normal.

5. The method according to claim 1, wherein the determining, by the scheduling device, to receive a response message returned by the service processing device comprises:
receiving, by the scheduling device, information sent from the service processing device;
acquiring, by the scheduling device, the stored response message, and matching the response message with the information; and
determining, by the scheduling device, to receive the response message returned by the service processing device upon determining that the response message and the information are matched.

6. The method according to claim 2, wherein the determining, by the scheduling device, to receive a response message returned by the service processing device comprises:
receiving, by the scheduling device, information sent from the service processing device;
acquiring, by the scheduling device, the stored response message, and matching the response message with the information; and
determining, by the scheduling device, to receive the response message returned by the service processing device upon determining that the response message and the information are matched.

7. The method according to claim 3, wherein the determining, by the scheduling device, to receive a response message returned by the service processing device comprises:
receiving, by the scheduling device, information sent from the service processing device;
acquiring, by the scheduling device, the stored response message, and matching the response message with the information; and
determining, by the scheduling device, to receive the response message returned by the service processing device upon determining that the response message and the information are matched.

8. The method according to claim 4, wherein the determining, by the scheduling device, to receive a response message returned by the service processing device comprises:
receiving, by the scheduling device, information sent from the service processing device;
acquiring, by the scheduling device, the stored response message, and matching the response message with the information; and
determining, by the scheduling device, to receive the response message returned by the service processing device upon determining that the response message and the information are matched.

9. A non-transitory computer storage medium storing a computer executable instruction, wherein the computer executable instruction is set for:
sending a service request to a service processing device; and
determining to receive a response message returned by the service processing device for the service request, and determining that a service state of the service processing device is that the service processing device can process the service request, wherein the response message is returned to the scheduling device after the service request is received by the service processing device in a case that the service processing device can process the service request.

10. The non-transitory computer storage medium according to claim 9, wherein the computer executable instruction is further used for:
determining not to receive the response message returned by the service processing device, and determining that the service state of the service processing device is that the service processing device cannot process the service request.

11. The non-transitory computer storage medium according to claim 9, wherein the sending a service request to a service processing device comprises:
storing the service request after receiving the service request, and sending the service request to the service processing device; or
sending a preset service request to the service processing device.

12. The non-transitory computer storage medium according to claim 9, wherein before the sending a service request to a service processing device, the computer executable instruction is further used for:
determining that an operation state of the service processing device is normal.

13. The non-transitory computer storage medium according to claim 9, the determining to receive a response message returned by the service processing device comprises:
receiving information sent from the service processing device;
acquiring the stored response message, and matching the response message with the information; and
determining to receive the response message returned by the service processing device upon determining that the response message and the information are matched.

14. The non-transitory computer storage medium according to claim 10, the determining to receive a response message returned by the service processing device comprises:
receiving information sent from the service processing device;
acquiring the stored response message, and matching the response message with the information; and
determining to receive the response message returned by the service processing device upon determining that the response message and the information are matched.

15. The non-transitory computer storage medium according to claim 11, the determining to receive a response message returned by the service processing device comprises:
receiving information sent from the service processing device;
acquiring the stored response message, and matching the response message with the information; and
determining to receive the response message returned by the service processing device upon determining that the response message and the information are matched.

16. A scheduling device, comprising:
at least one processor; and
a memory communicably connected with the at least one processor, wherein the memory stores instructions executable by the at least one processor;
wherein the at least one processor executes the instructions to:
send a service request to a service processing device; and
determine to receive a response message returned by the service processing device for the service request, and determine that a service state of the service processing device is that the service processing device can process the service request, wherein the response message is returned to the scheduling device after the service request is received by the service processing device in a case that the service processing device can process the service request.

17. The scheduling device according to claim 16, wherein the at least one processor is further configured to:
determine not to receive the response message returned by the service processing device, and determine that the service state of the service processing device is that the service processing device cannot process the service request.

18. The scheduling device according to claim 16, wherein when sending a service request to a service processing device, the at least one processor is specifically configured to:
store the service request after receiving the service request, and send the service request to the service processing device; or
send a preset service request to the service processing device.

19. The scheduling device according to claim 16, wherein the at least one processor is further configured to:
determine that an operation state of the service processing device is normal, before sending a service request to a service processing device.

20. The scheduling device according to claim 16, wherein when determining to receive a response message returned by the service processing device, the at least one processor is specifically configured to:
receive information sent from the service processing device;
acquire the stored response message, and match the response message with the information; and
determine to receive the response message returned by the service processing device upon determining that the response message and the information are matched.
